(19) United States
(12) Patent Application Publication
(10) Pub. No.: US 2021/0382903 A1
(43) Pub. Date: Dec. 9, 2021

(54) Obituary Indexing System and Method of Use

(71) Applicant: Bart Boxwell, Amarillo, TX (US)

(72) Inventor: Bart Boxwell, Amarillo, TX (US)

(21) Appl. No.: 16/946,071

(22) Filed: Jun. 4, 2020

(51) Int. Cl. G06F 16/2457; G06F 16/22

(52) U.S. Cl. CPC G06F 16/24575; G06F 16/2272

(57) ABSTRACT

A method of indexing obituary information and alerting potentially concerned parties being computer-implemented for tracking and notifying a plurality of users, comprising; collecting a plurality of a list of funeral homes and an obituary records collection with a server application. indexing an obituary record with an indexing algorithm; parsing the obituary records collection into a relationships data collection and a user timeline entries collection with the server application. collecting the user timeline entries collection and the relationships data collection from a one or more living users among the plurality of users of an obituary alerting system; comparing the user timeline entries collection and the relationships data collection as between the one or more living users with those of a deceased party having been indexed previously.

### CROSS-REFERENCE TO RELATED APPLICATIONS

Not applicable.

### STATEMENT REGARDING FEDERALLY SPONSORED RESEARCH OR DEVELOPMENT (IF APPLICABLE)

Not applicable.

### REFERENCE TO SEQUENCE LISTING, A TABLE, OR A COMPUTER PROGRAM LISTING COMPACT DISC APPENDIX (IF APPLICABLE)

Not applicable.

### BACKGROUND OF THE INVENTION

No prior art is known to the Applicant.

None of the known inventions and patents, taken either singularly or in combination, is seen to describe the instant disclosure as claimed.

### BRIEF SUMMARY OF THE INVENTION

A method of indexing obituary information and alerting potentially concerned parties being computer-implemented for tracking and notifying a plurality of users, the method is disclosed. Comprising implementing an obituary alerting system on a plurality of computers connected to one another over a network. collecting a plurality of a list of funeral homes and an obituary records collection with a server application. indexing an obituary record with an indexing algorithm. parsing said obituary records collection into a relationships data collection and a user timeline entries collection with said server application. collecting said user timeline entries collection and said relationships data collection from a one or more living users among said plurality of users of said obituary alerting system. comparing said user timeline entries collection and said relationships data collection as between said one or more living users with those of a deceased party having been indexed previously. sending one or more alerts to said one or more living users concerning said deceased party and said obituary record.

### BRIEF DESCRIPTION OF THE SEVERAL VIEWS OF THE DRAWING

FIG. 1 illustrates a network diagram 101 of an obituary alerting system 100.

FIGS. 2A, 2B, and 2C illustrate a perspective overview of a mobile phone 201a, a personal computer 201b and a tablet 201c, respectively.

FIGS. 3A, 3B, and 3C illustrate an address space 302, an address space 302a and an address space 302d within a plurality of computers 102.

FIGS. 4A, and 4B illustrate two embodiments for collecting and storing a data records 404 with said obituary alerting system 100.

FIGS. 5A, and 5B illustrate two examples of a flow diagram between a memory 306a and a memory 306d.

FIGS. 6A, and 6B illustrate a database relationship view of an application database 600, and an object relationship diagram 614 overview of said obituary alerting system 100.

FIG. 7 illustrates a login screen 704 of an obituary alerting system user interface 700.

FIG. 8 illustrates a user profile screen 800.

FIG. 9 illustrates an alerts screen 900.

FIG. 10 illustrates a my-activity screen 1000.

FIG. 11 illustrates a funeral directors admin screen 1100.

FIG. 12 illustrates data table view of a user list table 602.

FIG. 13 illustrates data table view of an user index table 604.

FIG. 14 illustrates data table view of an obit index table 606.

FIG. 15 illustrates data table view of a geo list table 608.

FIG. 16 illustrates data table view of an users cross reference table 610.

FIG. 17 illustrates an obituary record 1700.

FIG. 18 illustrates an annotated analysis 1802 of an obituary text 1708.

FIG. 19 illustrates an annotated analysis of one or more comments 1710.

FIG. 20 illustrates a family tree diagram 2000.

FIG. 21 illustrates a timeline diagram 2100.

Examples of problems solved with said obituary alerting system 100 follow.

FIG. 22 illustrates a detailed view of an obituary records collection 624.

FIG. 23 illustrates a method of indexing obituary information and alerting potentially concerned parties 2300.

### DETAILED DESCRIPTION OF THE INVENTION

The following description is presented to enable any person skilled in the art to make and use the invention as claimed and is provided in the context of the particular examples discussed below, variations of which will be readily apparent to those skilled in the art. In the interest of clarity, not all features of an actual implementation are described in this specification. It will be appreciated that in the development of any such actual implementation (as in any development project), design decisions must be made to achieve the designers' specific goals (e.g., compliance with system- and business-related constraints), and that these goals will vary from one implementation to another. It will also be appreciated that such development effort might be complex and time-consuming, but would nevertheless be a routine undertaking for those of ordinary skill in the field of the appropriate art having the benefit of this disclosure. Accordingly, the claims appended hereto are not intended to be limited by the disclosed embodiments, but are to be accorded their widest scope consistent with the principles and features disclosed herein.

These parts are illustrated in the figures and discussed below:

an obituary alerting system 100,

a network diagram 101,

a plurality of computers 102,

a first computer 102a,

a second computer 102b,

a third computer 102c,

a one or more locations 103,

a first location 103a,

a second location 103b,

a third location 103c,

a printer 104,

a network 106,

a server 108,

a data storage 110,

a data storage 110a,

a mobile phone 201a,

a personal computer 201b,

a tablet 201c,

a screen 202,

a one or more input devices 204,

a keyboard 204a,

a trackball 204b,

a one or more cameras 204c,

a track pad 204d,

a home button 220,

an address space 302,

an address space 302a,

an address space 302b,

an address space 302c,

an address space 302d,

a processor 304,

a processor 304a,

a processor 304b,

a processor 304c,

a processor 304d,

a memory 306,

a memory 306a,

a memory 306b,

a memory 306c,

a memory 306d,

a communication hardware 308,

a communication hardware 308a,

a communication hardware 308b,

a communication hardware 308c,

a communication hardware 308d,

a device application 402,

a data records 404,

a server application 406,

an application database 600,

a user list table 602,

an ID 602a,

a first name 602b,

a last name 602c,

a password 602d,

a living 602e,

a deceased 602f,

a relative 602g,

a publisher 602h,

an username 602k,

an user index table 604,

an ID 604a,

a geo ref 604b,

a start date 604c,

an end date 604d,

a key word 604e,

a work 604f,

a social group 604g,

an user ref 604h,

an alert 604k,

an obit index table 606,

an ID 606a,

a date published 606b,

a title 606c,

an obit 606d,

a deceased ref 606e,

a publisher ref 606f,

a geo ref 606g,

a date death 606h,

a geo list table 608,

a geo ID 608a,

a city 608b,

a state 608c,

a population 608d,

an users cross reference table 610,

a CRT-ID 610a,

a first user 610b,

a second user 610c,

a user index ref 610d,

a one or more obituary sources 612,

an obituary alerting system user interface 700,

a navigation bar 702,

a login tab 702a,

an user profile tab 702b,

an alerts tab 702c,

a my-activity tab 702d,

a funeral directors admin tab 702e,

a login screen 704,

a login zone 706,

a new user zone 708,

a login button 710,

a create user account button 712,

an user prompt 720,

a password prompt 722,

a create username prompt 726,

a create password prompt 728,

a user profile screen 800,

a user data zone 802,

a user associations zone 804,

a logged in user 810,

an update user profile button 820,

an update user associations button 822,

a one or more associations 824,

an alerts screen 900,

a recently deceased zone 902,

a related details zone 904,

a comments zone 906,

a gift ordering zone 908,

a load related details button 920,

a send gift button 922,

a leave comment button 924,

a my-activity screen 1000,

a user associations zone 1004,

an update user associations button 1022,

a funeral directors admin screen 1100,

an update obit button 1120,

a create obit button 1122,

an archive obit button 1124,

a delete obit button 1126,

a one or more living users 1200,

a one or more deceased users 1202, and

a plurality of users 1204.

Additional parts are introduced throughout the detailed description below.

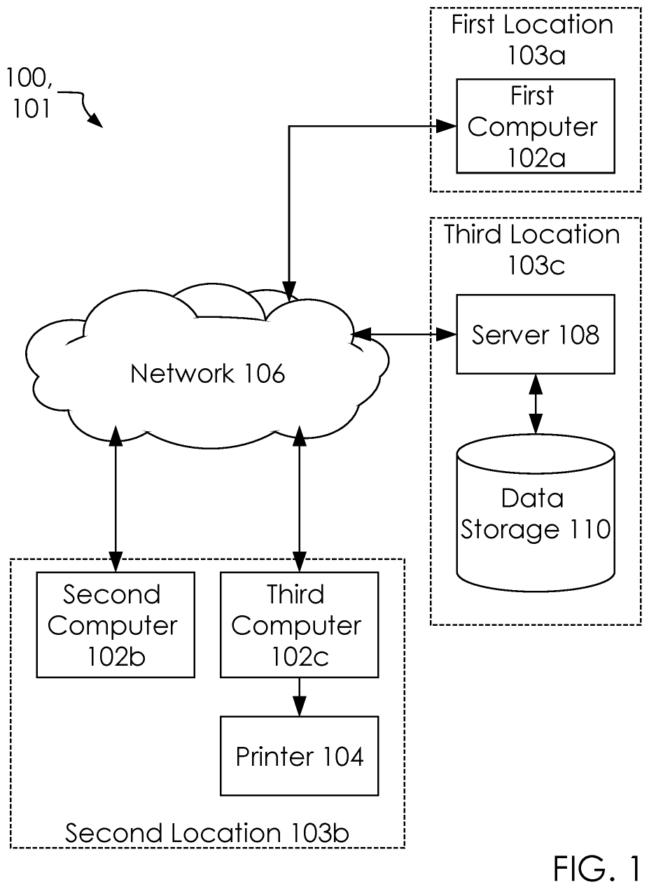

FIG. 1 illustrates said network diagram 101 of said obituary alerting system 100.

In one embodiment, said obituary alerting system 100 can comprise a one or more computers at said one or more locations 103.

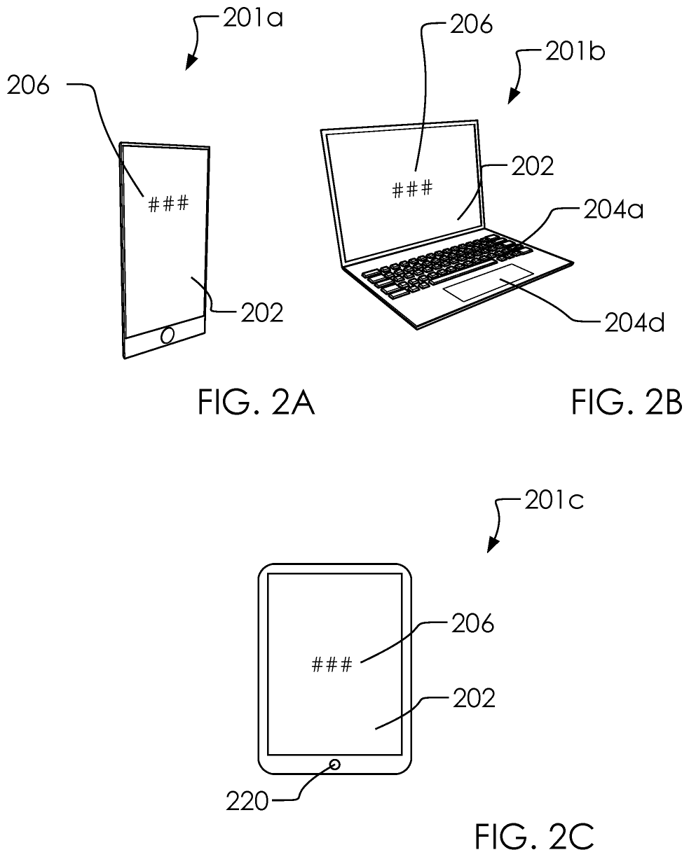

FIGS. 2A, 2B, and 2C illustrate a perspective overview of said mobile phone 201a, said personal computer 201b and said tablet 201c, respectively.

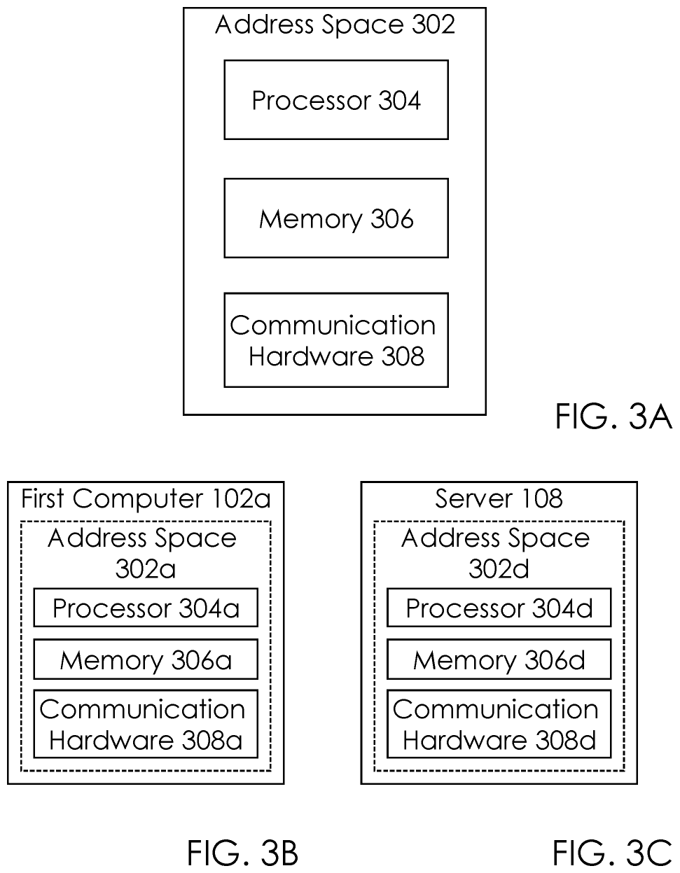

FIGS. 3A, 3B, and 3C illustrate said address space 302, said address space 302a and said address space 302d within said plurality of computers 102.

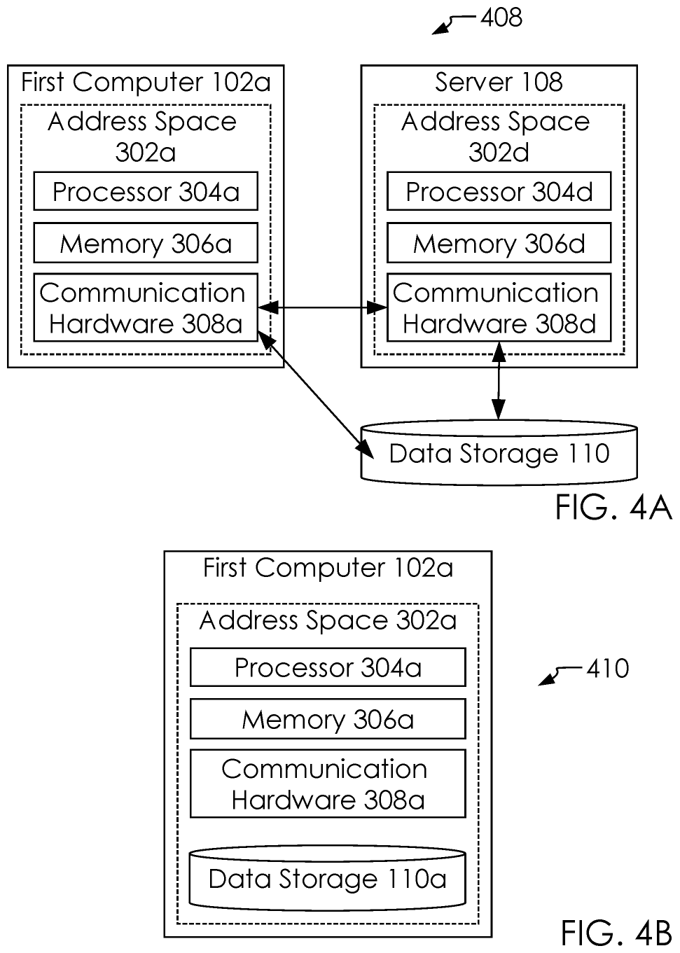

FIGS. 4A, and 4B illustrate two embodiments for collecting and storing said data records 404 with said obituary alerting system 100.

A first embodiment can comprise a flow diagram 408 illustrating data moving between said first computer 102a and said server 108, and a second embodiment 410 comprising of just said first computer 102a.

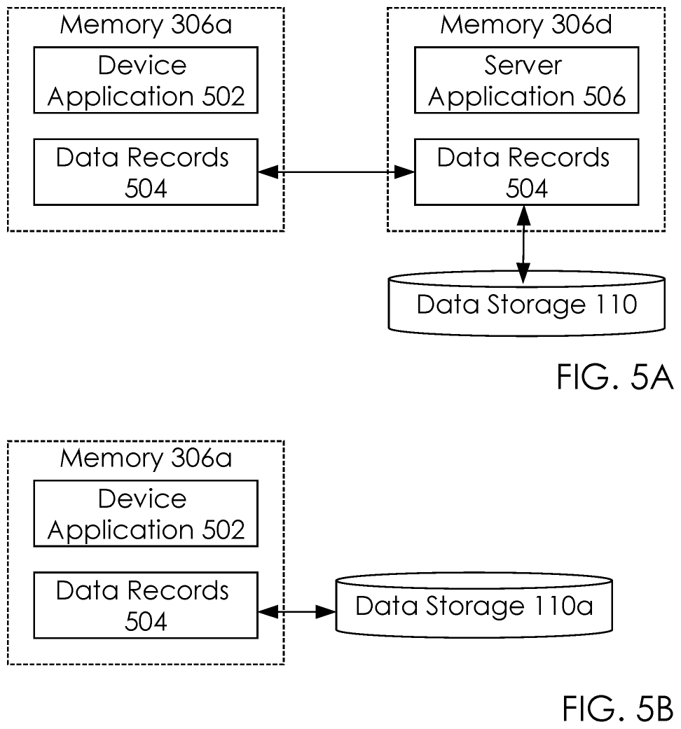

FIGS. 5A, and 5B illustrate two examples of a flow diagram between said memory 306a and said memory 306d.

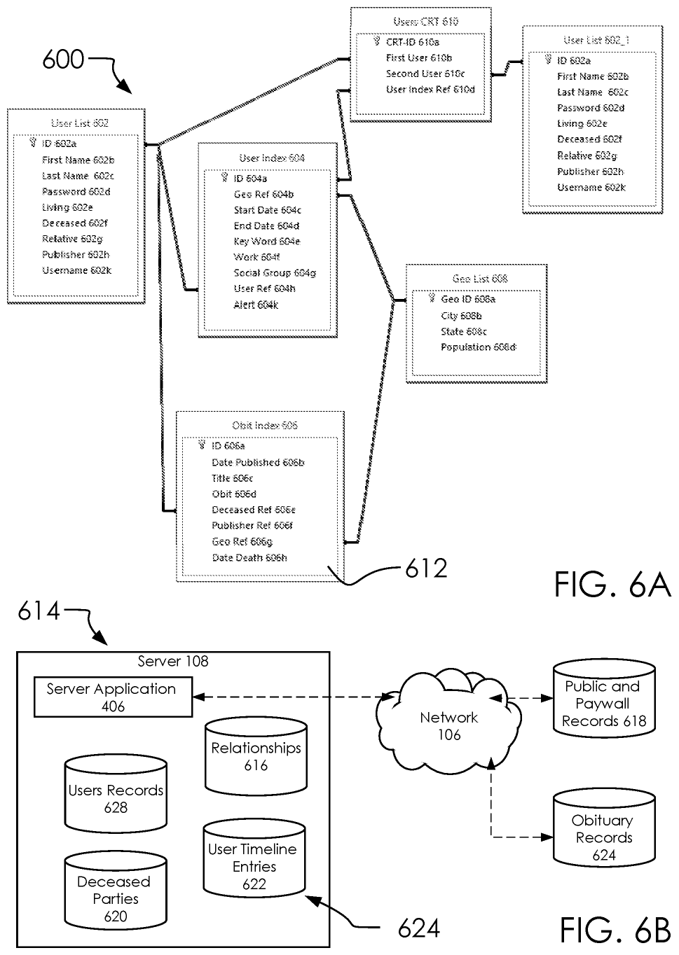

FIGS. 6A, and 6B illustrate a database relationship view of said application database 600, and an object relationship diagram 614 overview of said obituary alerting system 100.

In one embodiment, said application database 600 can comprise an example of a set of tables to be used to administrate said device application 402. In one embodiment, said user list table 602 can be shown in multiple places in this view as it is referenced by more than one table among said application database 600, as is known in the art.

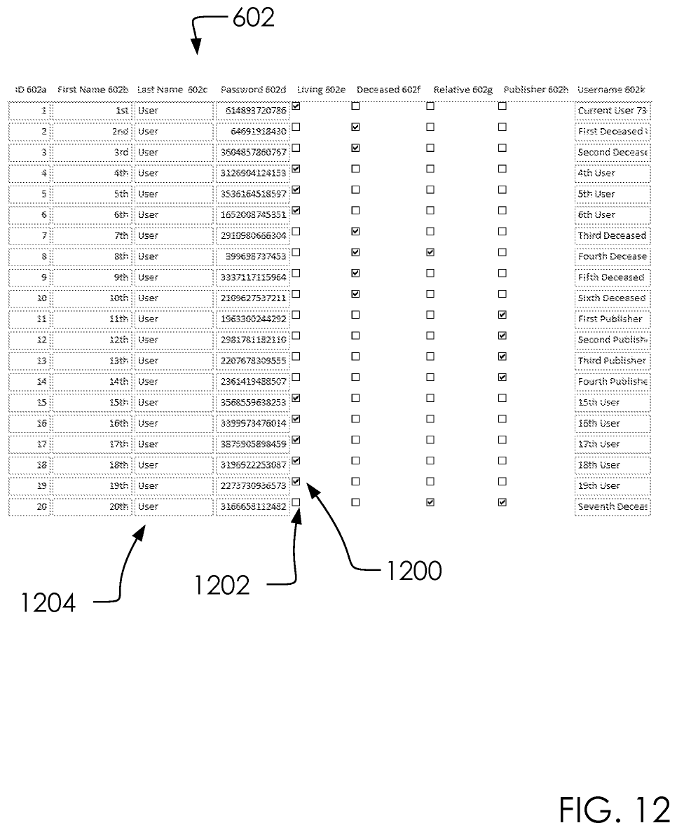

Functionality of each table can be ascertained as described to come and as is known in the art. Details of the individual fields within each table can be found in the descriptions of FIG. 12 and following.

In one embodiment, said user list table 602 can comprise a collection of data related to each user in said device application 402. For example, in one embodiment, each user may have an alias which can comprise a unique value comprising said username 602k. Likewise, said password 602d can be used for logging into said device application 402.

In one embodiment, said user index table 604 can comprise a collection of activities and history related to each user within said user list table 602, as discussed below.

In one embodiment, said obit index table 606 can comprise an index of a one or more obituaries having been found by or entered into said obituary alerting system 100. In one embodiment, said obit index table 606 can be populated with data collected while crawling around the web or otherwise entered into said obituary alerting system 100 directly.

In one embodiment, said geo list table 608 can be referred to identify a location such as said city 608b, state or similar.

In one embodiment, said obituary alerting system 100 can populate said users cross reference table 610 by comparing details related to each among said user list table 602 with one another and finding a one or more overlapping activities. In one embodiment, such one or more overlapping activities can be characterized in said user index table 604. In one embodiment, each user in said user list table 602 can set a flag to determine the urgency and interest of said alert 604k or activity by setting said alert 604k, as discussed to come.

Said object relationship diagram 614 can comprise a flow chart between said server application 406 and a collection of data objects 626 (which can comprise a user records collection 628, a relationships data collection 616, a public and paywall records collection 618, a deceased parties collection 620, a user timeline entries collection 622, and an obituary records collection 624).

By contrast, said object relationship diagram 614 illustrates a more high-level configuration of said obituary alerting system 100. Said user records collection 628 can comprise portions of said user list table 602 and said one or more obituary sources 612; said relationships data collection 616 can comprise portions of said user list table 602 and said users cross reference table 610; said deceased parties collection 620 can comprise portions of said user list table 602 and said obit index table 606; said user timeline entries collection 622 can comprise portions of said user list table 602, said user index table 604 and said geo list table 608; and said obituary records collection 624 can comprise portions of said user list table 602, and said obit index table 606.

In one embodiment, said obituary alerting system 100 can use said server application 406 to modify and maintain said obituary records collection 624. Further, said server application 406 can communicate with said public and paywall records collection 618 and said obituary records collection 624 to enhance alerts generated by said obituary alerting system 100.

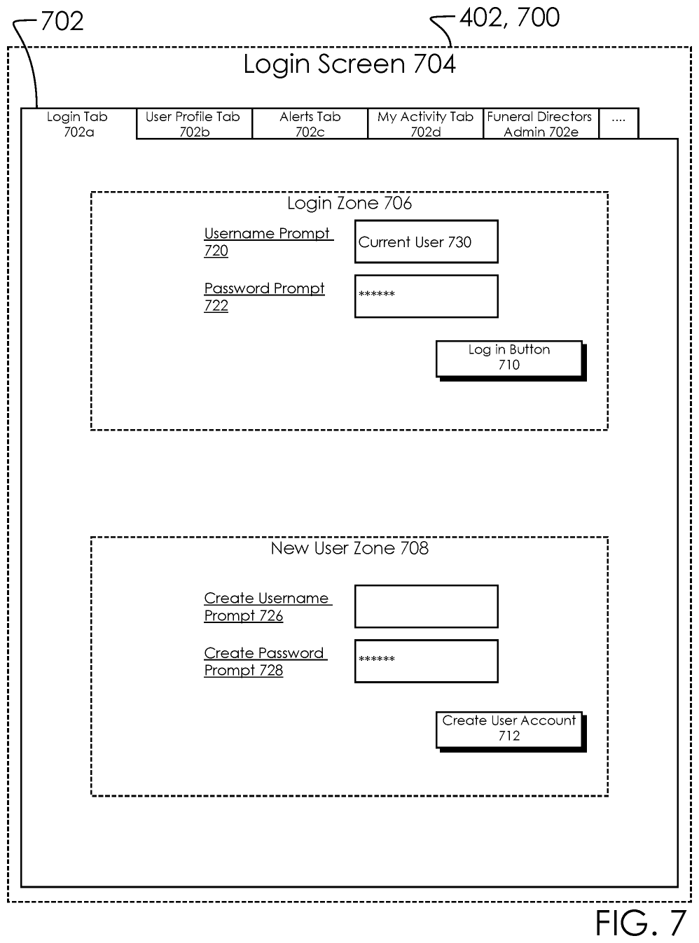

FIG. 7 illustrates said login screen 704 of said obituary alerting system user interface 700.

In one embodiment, said login screen 704 can be used for accessing contents within said obituary alerting system 100, as is known in the art.

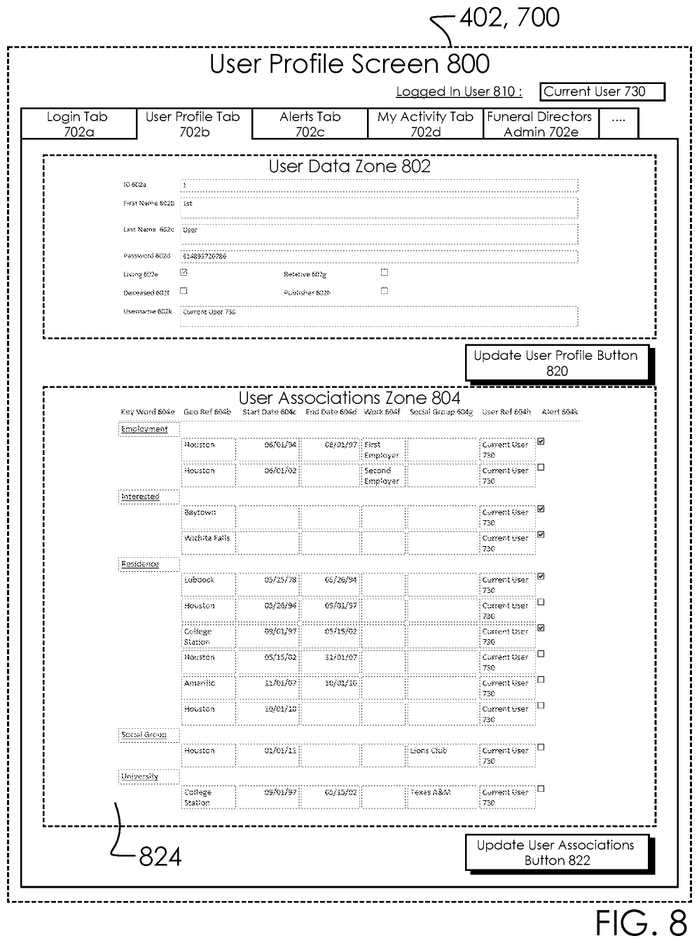

FIG. 8 illustrates said user profile screen 800.

In one embodiment, said plurality of users 1204 can arrive at said user profile screen 800 after logging into said obituary alerting system 100 at said login tab 702a. In one embodiment, said user profile screen 800 can comprise said user data zone 802 with said update user profile button 820, used for updating data related to said plurality of users 1204.

In one embodiment, said user associations zone 804 with said update user associations button 822 can be used for reviewing associations related to said plurality of users 1204. For example, in one embodiment, said plurality of users 1204 can have two prior employers in said obituary alerting system 100 including a “First Employer” and a “Second Employer”, as illustrated; wherein, dates, locations and said alert 604k flag can be set to determine whether said plurality of users 1204 wishes to receive updates related to these periods of his or her life.

Likewise, in one embodiment, said key word 604e can illustrate different portions of a user's life which can be categorized within said obituary alerting system 100, including employment, interested locations, residences, social groups, universities, churches (not illustrated here), and similar. In fact, said plurality of users 1204 can set up a variety of associations here and receive data from those associations in the future. In one embodiment, said “Interested” category for said key word 604e can comprise associations which said plurality of users 1204 is interested in but has not resided in or participated in at any time. Thus, said plurality of users 1204 can receive updates from all kinds of interests for said obituary alerting system 100.

In one embodiment, said update user profile button 820 and said update user associations button 822 can operate as known in the art.

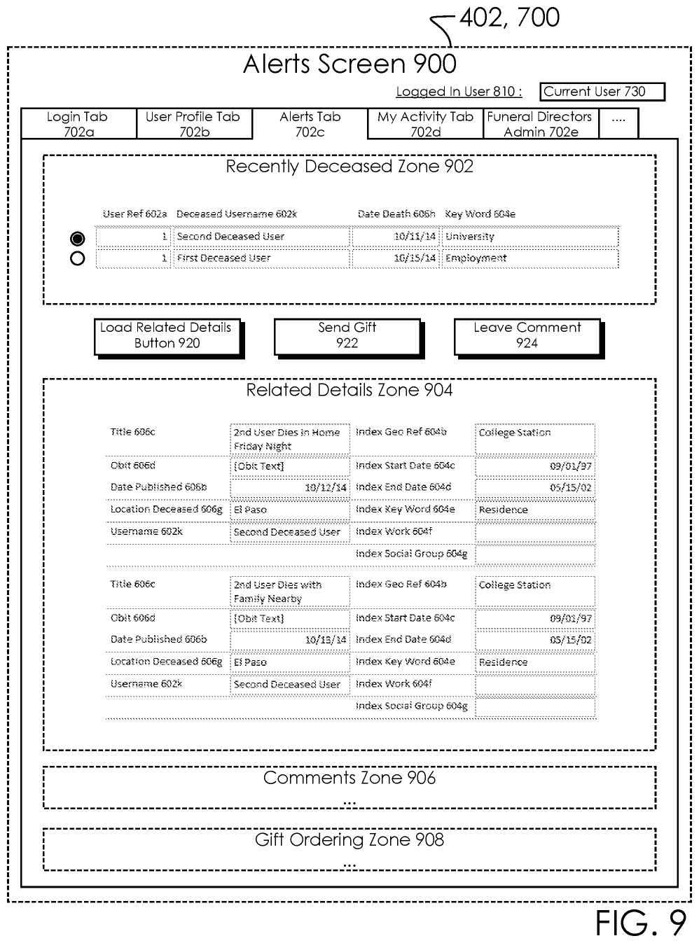

FIG. 9 illustrates said alerts screen 900.

In one embodiment, said alerts screen 900 for said alert 604k can be a set of alerts related to recently deceased persons which are populated into said recently deceased zone 902. In one embodiment, a list of persons being of interest to said plurality of users 1204 can comprise those with common associations having been manually set in said user associations zone 804 or otherwise anticipated by said obituary alerting system 100 with artificial intelligence, educated guessing, or similar, as is known in the art.

In one embodiment, said plurality of users 1204 can select one among a one or more records in said recently deceased zone 902, and then press either said load related details button 920, said send gift button 922 ANDOR said leave comment button 924. In one embodiment, said load related details button 920 can load more details related to a record into said related details zone 904. In one embodiment, said send gift button 922 can launch a gift giving dialog to be delivered to a service for said deceased 602f party, such as said gift ordering zone 908, and known in the art. In one embodiment, said leave comment button 924 can load a comments entry area, such as said comments zone 906.

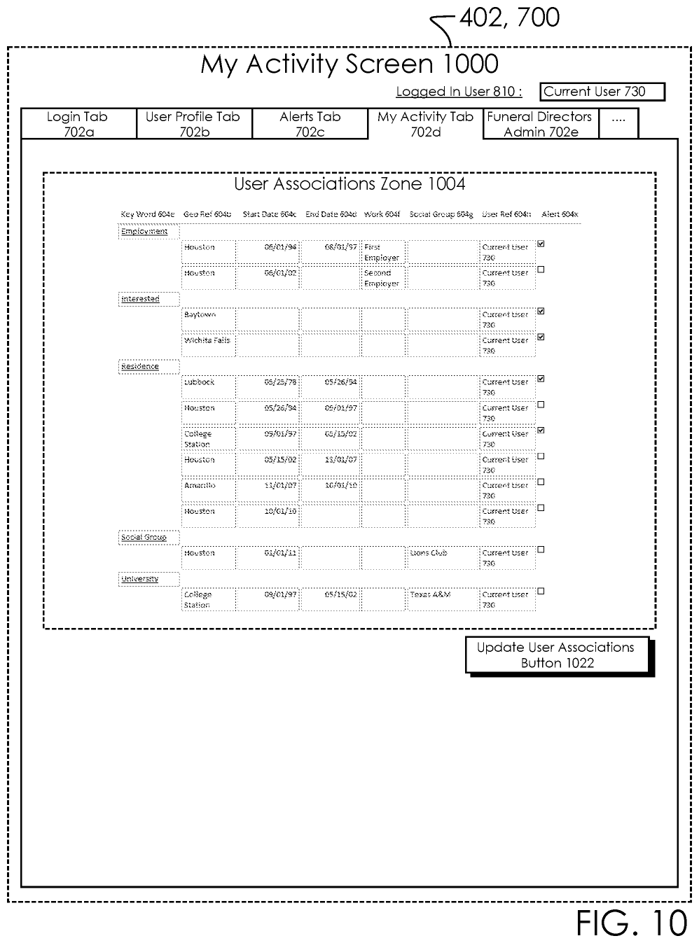

FIG. 10 illustrates said my-activity screen 1000.

In one embodiment, said user associations zone 804 1004 can display data similar to said user associations zone 804, in more or less detail, as is known in the art.

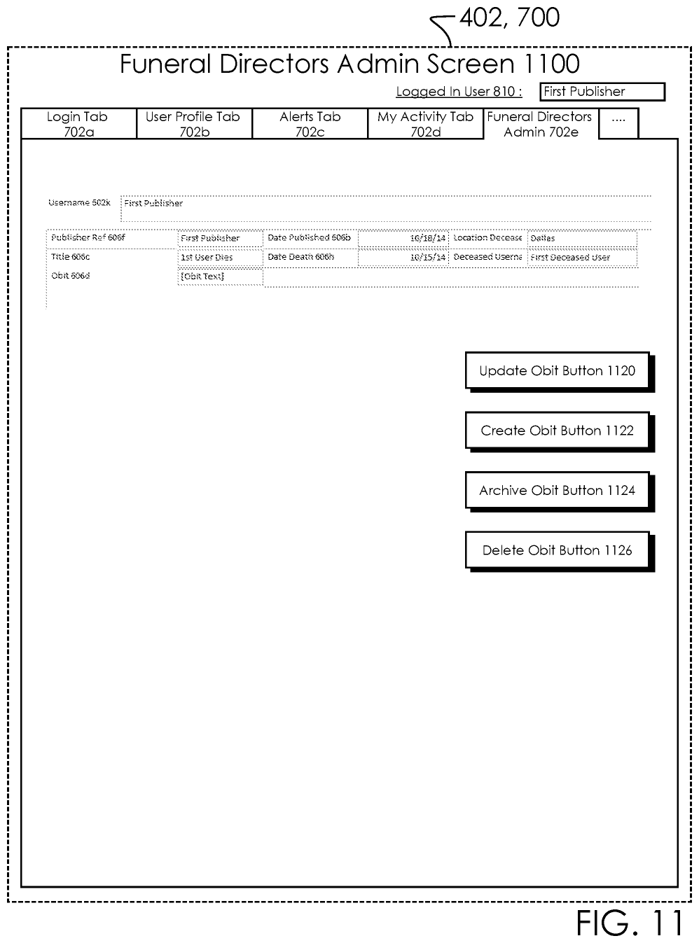

FIG. 11 illustrates said funeral directors admin screen 1100.

Note that said logged in user 810 no comprises a “First Publisher” as provided by said user list table 602.

In one embodiment, said First Publisher can comprise a one or more obituaries which need to be edited manually within said device application 402 and he can do so on said funeral directors admin screen 1100, as is known in the art.

FIG. 12 illustrates data table view of said user list table 602.

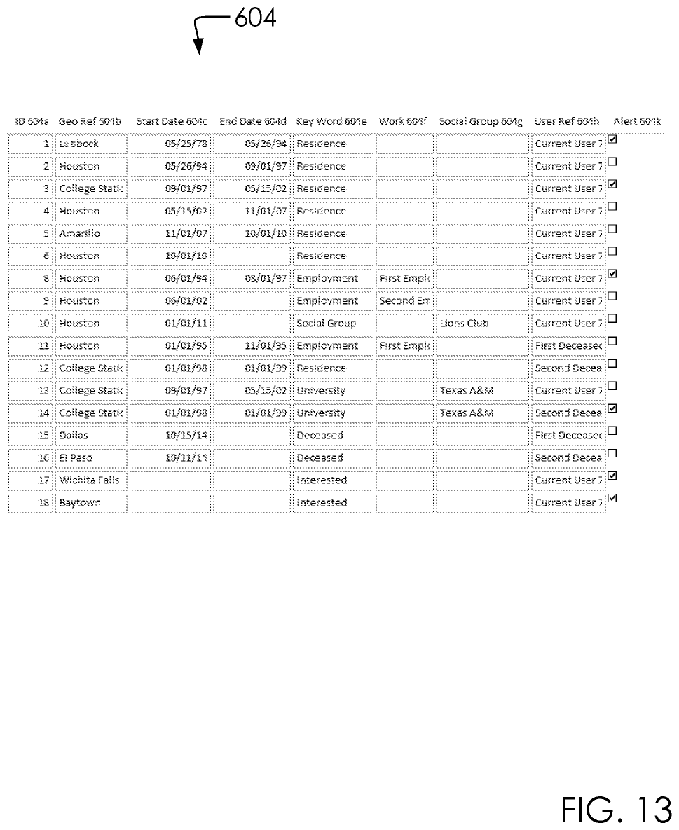

FIG. 13 illustrates data table view of said user index table 604.

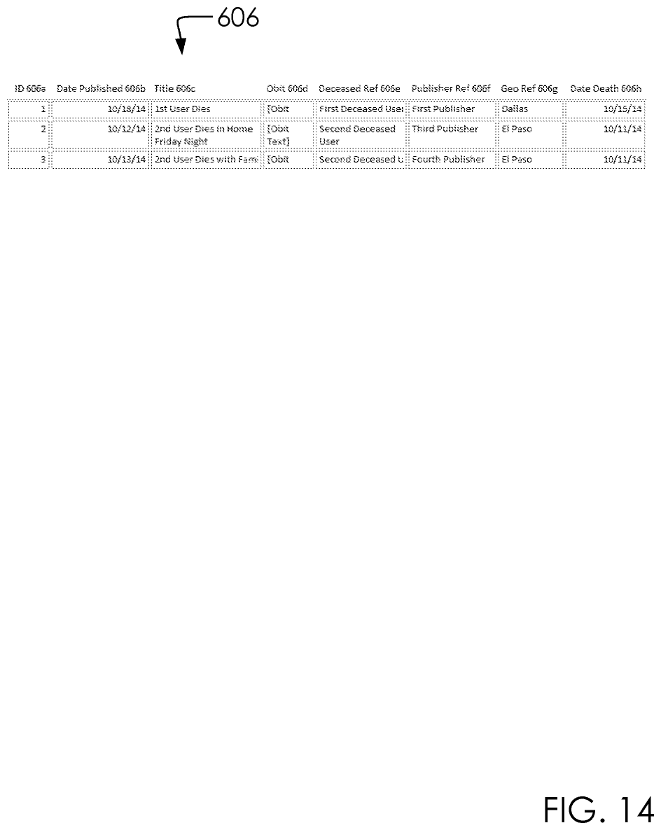

FIG. 14 illustrates data table view of said obit index table 606.

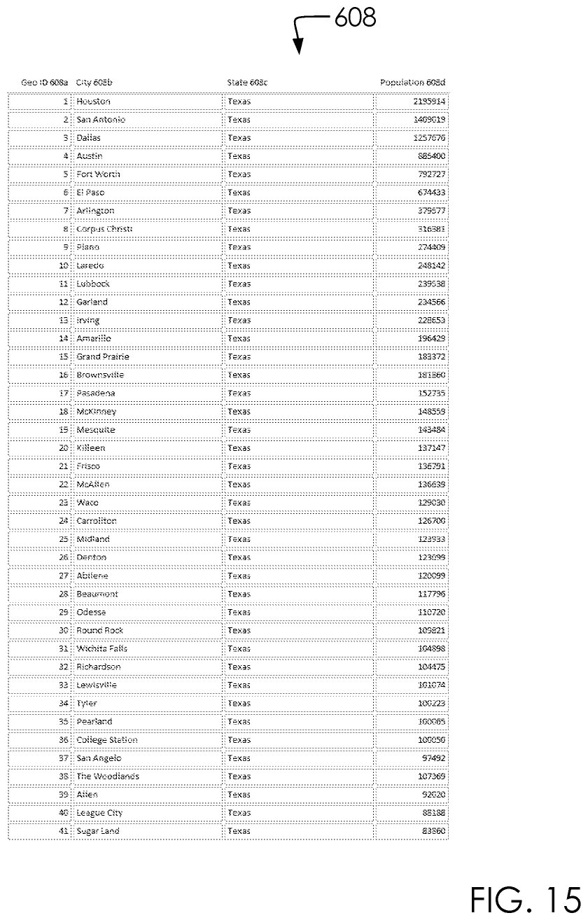

FIG. 15 illustrates data table view of said geo list table 608.

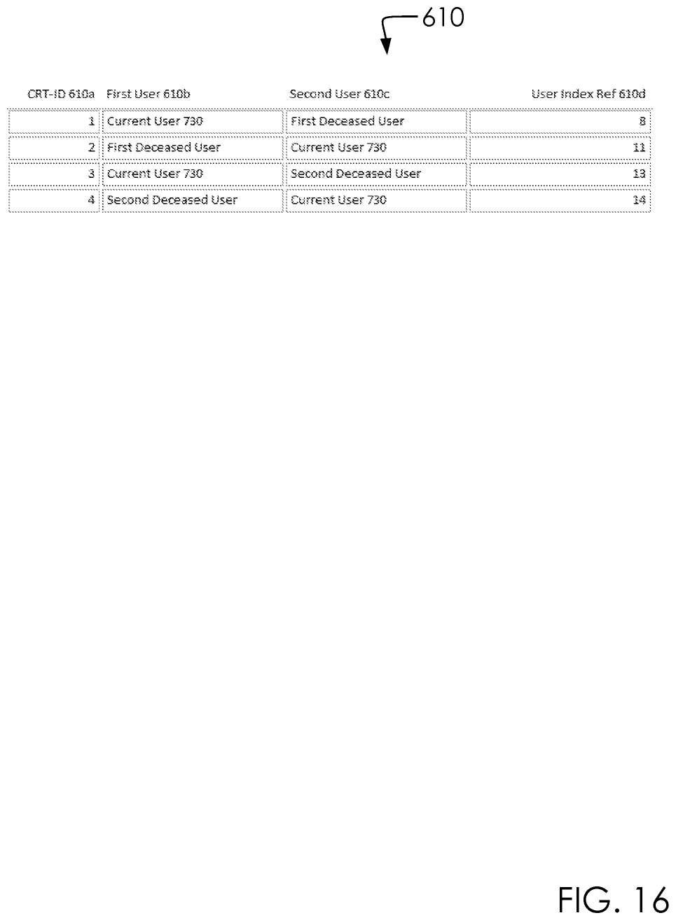

FIG. 16 illustrates data table view of said users cross reference table 610.

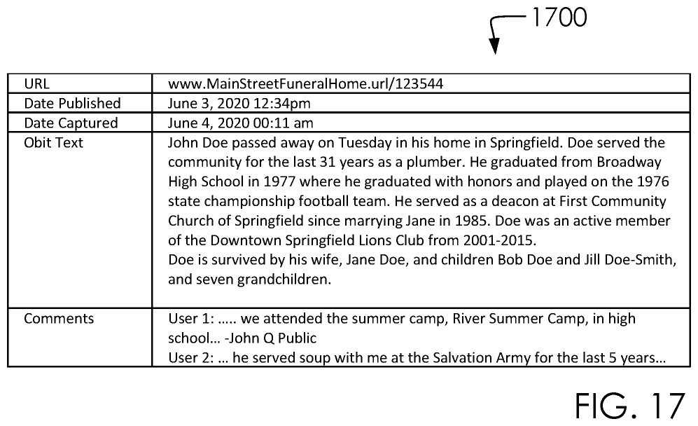

FIG. 17 illustrates an obituary record 1700.

In one embodiment, each among said obituary record 1700 can comprise a source URL 1702, a date published 1704, a date captured 1706, an obituary text 1708, and one or more comments 1710. Said obituary record 1700 can comprise form a portion of said obituary records collection 624.

In one embodiment, said server application 406 can locate and index said obituary records collection 624 from across the internet for analysis and interpretation.

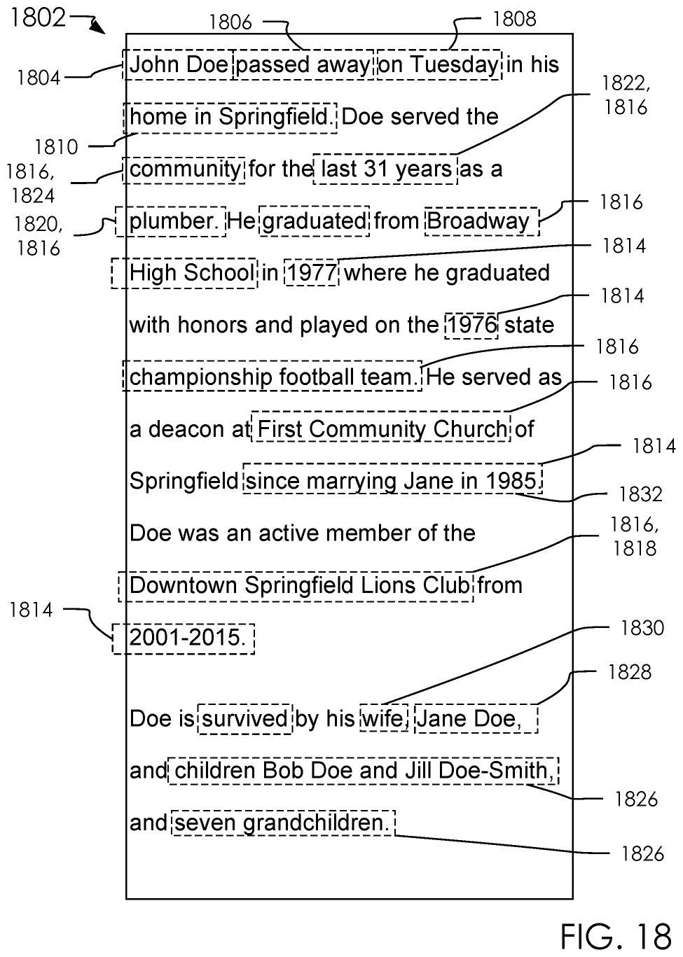

FIG. 18 illustrates an annotated analysis 1802 of said obituary text 1708.

Crawling and indexing obituary text is different from other text on the internet. For example, a spider indexing algorithm may find various facts about vacation homes such as location, availability, amenities and so forth. Product reviews of hardware may include users ratings, descriptions of the goods and so forth. These examples illustrate that various goods on the internet have well known data and corresponding data structures which must be crawled and indexed according to well recognized patters. Obituaries, on the other hand, represent a summary of a person's life, including accomplishments, familial relationships, and ample opportunity for mistaking one person for another with a similar or identical name. accordingly, said obituary alerting system 100 has been designed to overcome shortcomings of existing indexing strategies in order to provide value to its users.

Turning to said obituary text 1708, we note that the text is unstructured but may follow styling guidelines established and followed by newspapers and publications. However, different populations may use distinctive dialects to communicate the same thing. For example, to communicate that someone has died, it may be customary among religious persons to say that they “went to be with the Lord” as opposed to “died” or “passed away”. said server application 406 can comprise an indexing algorithm 1800 used to interpret said obituary text 1708. Said indexing algorithm 1800 is illustrated by description herein and by flow chart below.

Said indexing algorithm 1800 can identify a deceased person's name 1804, a phrase indication of death 1806, a relative date of death 1808, a relative location of death 1810, one or more timeline entries 1812, and one or more party relationships 1826.

Said server application 406 can use said relative date of death 1808 and said date published 1704 can be used to calculate said date death 606h.

Said one or more timeline entries 1812 can each comprise a timeline date range 1814, a timeline description 1816 and/or a timeline location 1818. One such example can comprise a job description 1820, a job timeframe 1822, and a job location 1824.

Said or more party relationships 1826 can comprise a party name 1828, a relationship type 1830, and a relationship date range 1832.

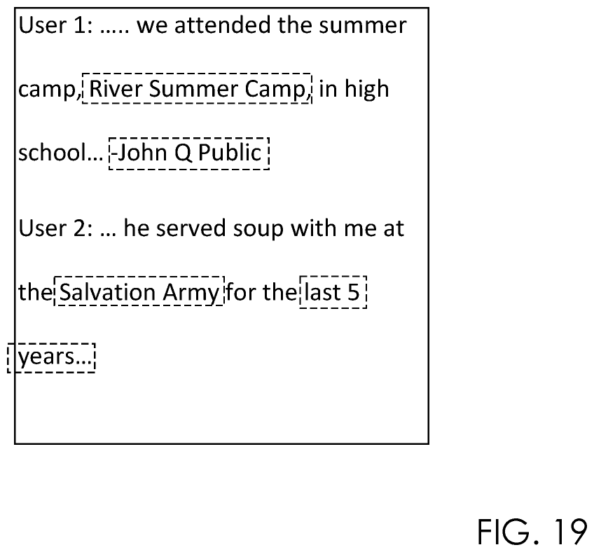

FIG. 19 illustrates an annotated analysis of said one or more comments 1710.

Likewise, said server application 406 can index said one or more comments 1710 associated with said obituary record 1700 to discover said one or more timeline entries 1812 and said or more party relationships 1826, as illustrated.

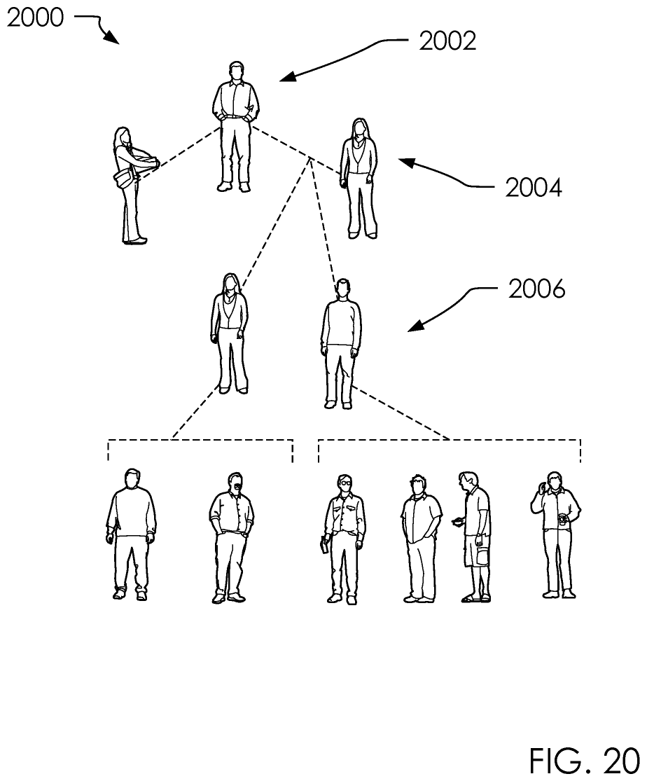

FIG. 20 illustrates a family tree diagram 2000.

Said obituary alerting system 100 can organize said obituary record 1700 inputs into a relationship structure for said relationships data collection 616. For example, said or more party relationships 1826 can be indexed to associate with a deceased party 2002; identify one or more spouses 2004, and one or more descendants 2006.

Said family tree diagram 2000 can be generated from said relationships data collection 616 and used to compare with said public and paywall records collection 618 to increase confidence in guesses made by said indexing algorithm 1800 and to generate one or more alerts 2008 for said alerts screen 900.

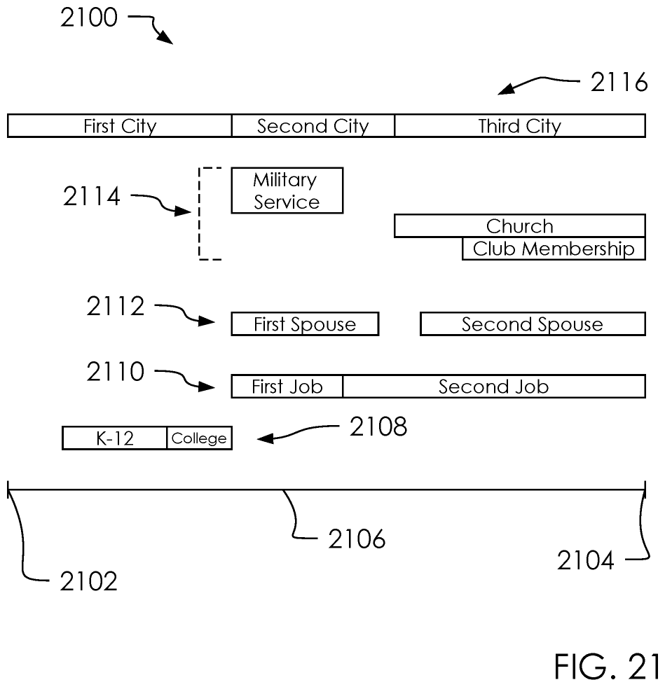

FIG. 21 illustrates a timeline diagram 2100.

Said timeline diagram 2100 can comprise a birth date 2102 and a death date 2104 organized at two ends of a timeline 2106.

Said obituary alerting system 100 can organize said one or more timeline entries 1812 into said timeline diagram 2100, as illustrated. Said one or more timeline entries 1812 can comprise one or more learning institutions 2108, one or more jobs 2110, one or more marriages 2112, one or more organization affiliations 2114, and/or one or more residences 2116.

By comparing said one or more timeline entries 1812 for said deceased party 2002 with said one or more living users 1200, said obituary alerting system 100 can generate more useful alerts in said one or more alerts 2008 for said one or more living users 1200.

Examples of problems solved with said obituary alerting system 100 follow.

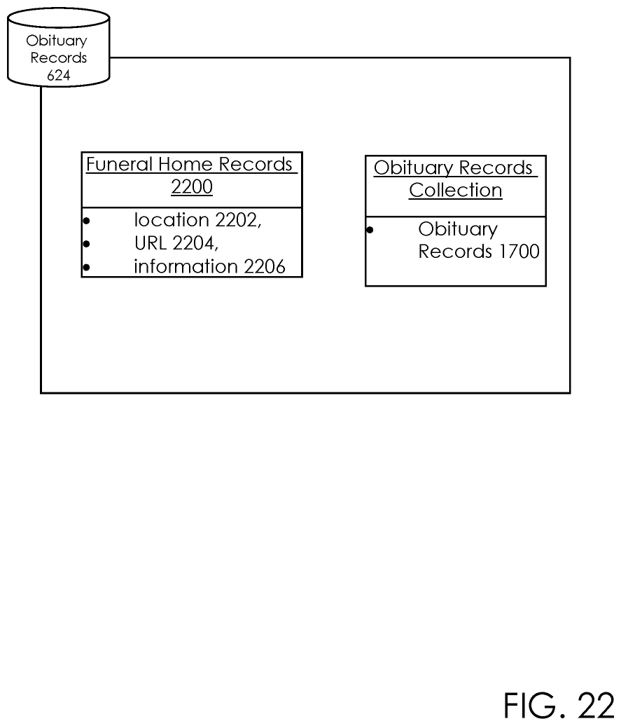

FIG. 22 illustrates a detailed view of said obituary records collection 624.

Said obituary records collection 624 can comprise a list of funeral homes 2200, each comprising a funeral home location 2202, a funeral home website URL 2204, and a funeral home information 2206. Said obituary alerting system 100 can utilize said list of funeral homes 2200 to index said obituary record 1700 to fill in missing information and thereby populate said family tree diagram 2000 with said relationships data collection 616, and said timeline diagram 2100 with said user timeline entries collection 622.

In one embodiment, the funeral homes are stored in the database with their addresses, locations & websites. The funeral home website provided by the scrapper is matched with the existing funeral homes and get the funeral home from the database for that obituary record.

In one embodiment, said funeral home website URL 2204 are complete in structure i.e. https://www.funeral-home.com. On occasion, the scrapped URL lacks some keywords like http, www, and similar. In one embodiment, said obituary alerting system 100 can filter a scraped URL with and without protocols, domain and even the proper noun name of the funeral home to associate an obituary with an home in said list of funeral homes 2200.

In one embodiment, scrapping the birthplace and place of death for said deceased party 2002 can be accomplished by looking for “born”, “birth”, “born in”, or similar.

Extracting a precise date of death can comprise filtering 1808/by: using the keywords lookup such as “death”, “died”, “passed” and similar; and removing extra words from the sentence like days of week, “early”, “late”, and similar.

In some cases where multiple dates are found, an assumption can be made that the earliest date is the birthdate and the latest date is the date of death. Thereafter, said obituary text 1708 can be used to check this assumption.

Where the birth and death dates are not present, then the age is extracted using the keyword lookup using the keywords “Age”, ‘Age of’, “of age” and similar.

Finally, said obituary alerting system 100 can extract funeral events from said obituary text 1708, such as the date, time and location of a funeral service. Here, keywords such as “service” or “in memory” can be helpful.

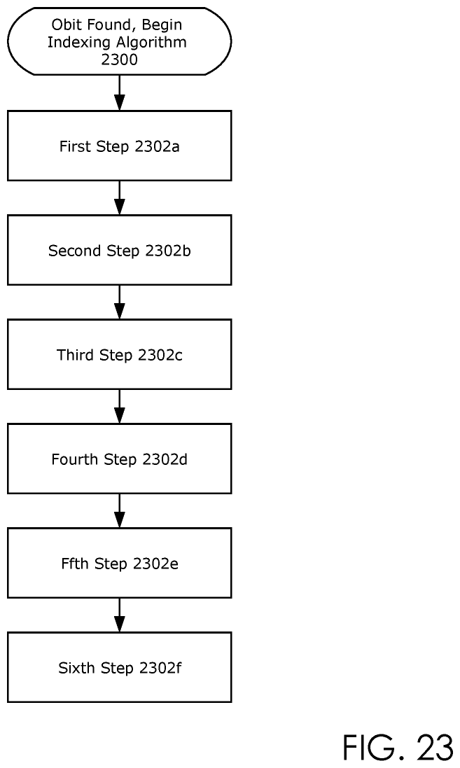

FIG. 23 illustrates a method of indexing obituary information and alerting potentially concerned parties 2300.

In one embodiment, said method of indexing obituary information and alerting potentially concerned parties 2300 can comprise one or more steps 2302 (which can comprise a first step 2302a, a second step 2302b, a third step 2302c, a fourth step 2302d, a fifth step 2302e, and a sixth step 23020.

Said first step 2302a can comprise collecting a plurality of said list of funeral homes 2200 and said obituary records collection 624 with said server application 406.

Said second step 2302b can comprise indexing said obituary record 1700 with said indexing algorithm 1800.

Said third step 2302c can comprise parsing said obituary records collection 624 into said relationships data collection 616 and said user timeline entries collection 622 with said server application 406.

Said fourth step 2302d can comprise collecting said user timeline entries collection 622 and said relationships data collection 616 from said one or more living users 1200 among said plurality of users 1204 of said obituary alerting system 100.

Said fifth step 2302e can comprise comparing said user timeline entries collection 622 and said relationships data collection 616 as between said one or more living users 1200 with those of said deceased party 2002 having been indexed previously.

Said sixth step 2302f can comprise sending said one or more alerts 2008 to said one or more living users 1200 concerning said deceased party 2002 and said obituary record 1700.

The following sentences are included for completeness of this disclosure with reference the claims.

Said method of indexing obituary information and alerting potentially concerned parties 2300 being computer-implemented for tracking and notifying said plurality of users 1204, the method can comprise implementing said obituary alerting system 100 on said plurality of computers 102 connected to one another over said network 106. collecting a plurality of said list of funeral homes 2200 and said obituary records collection 624 with said server application 406. indexing said obituary record 1700 with said indexing algorithm 1800. parsing said obituary records collection 624 into said relationships data collection 616 and said user timeline entries collection 622 with said server application 406. collecting said user timeline entries collection 622 and said relationships data collection 616 from said one or more living users 1200 among said plurality of users 1204 of said obituary alerting system 100. comparing said user timeline entries collection 622 and said relationships data collection 616 as between said one or more living users 1200 with those of said deceased party 2002 having been indexed previously. sending said one or more alerts 2008 to said one or more living users 1200 concerning said deceased party 2002 and said obituary record 1700.

Said one or more associations 824 comprise a list of persons being of interest to said plurality of users 1204 having common associations. Said method of indexing obituary information and alerting potentially concerned parties 2300 comprises said device application 402 for use by said plurality of users 1204. Said method of indexing obituary information and alerting potentially concerned parties 2300 comprises said server 108 application for indexing said one or more obituary sources 612 and said one or more associations 824 into said obit index table 606 in said application database 600, and creating a portion of said one or more associations 824 with artificial intelligence applied to said obit index table 606.

Said method of indexing obituary information and alerting potentially concerned parties 2300 comprises said device application 402 for use by said plurality of users 1204. 2300/comprises said server 108 application for indexing said plurality of users 1204 and said one or more associations 824 in said application database 600, indexing said one or more obituary sources 612 and updating said application database 600 with said one or more obituary sources 612, and notifying said one or more living users 1200 on related information for said one or more deceased users 1202 among said plurality of users 1204 based on said one or more obituary sources 612 and said one or more associations 824.

Said one or more associations 824 comprise a list of persons being of interest to said plurality of users 1204 can comprise those with common associations having been manually set in said device application 402.

Said one or more associations 824 comprise a list of persons being of interest to said plurality of users 1204 can comprise those with common associations having been manually set in said device application 402. Said method of indexing obituary information and alerting potentially concerned parties 2300 comprises said device application 402 for use by said plurality of users 1204. Said method of indexing obituary information and alerting potentially concerned parties 2300 comprises said server 108 application for indexing said plurality of users 1204 and said one or more associations 824 in said application database 600, indexing said one or more obituary sources 612 and updating said application database 600 with said one or more obituary sources 612. notifying said one or more living users 1200 on related information for said one or more deceased users 1202 among said plurality of users 1204 based on said one or more obituary sources 612 and said one or more associations 824.

1. A method of indexing obituary information and alerting potentially concerned parties being computer-implemented for tracking and notifying a plurality of users, the method comprising:
implementing an obituary alerting system on a plurality of computers connected to one another over a network;
collecting a plurality of a list of funeral homes and an obituary records collection with a server application;
indexing an obituary record with an indexing algorithm;
parsing said obituary records collection into a relationships data collection and a user timeline entries collection with said server application;
collecting said user timeline entries collection and said relationships data collection from a one or more living users among said plurality of users of said obituary alerting system;
comparing said user timeline entries collection and said relationships data collection as between said one or more living users with those of a deceased party having been indexed previously; and
sending one or more alerts to said one or more living users concerning said deceased party and said obituary record.

2. The method of indexing obituary information and alerting potentially concerned parties from claim 1, wherein:
a one or more associations comprise a list of persons being of interest to said plurality of users having common associations;
said method of indexing obituary information and alerting potentially concerned parties comprises a device application for use by said plurality of users;
said method of indexing obituary information and alerting potentially concerned parties comprises a server application for
indexing a one or more obituary sources and said one or more associations into an obit index table in an application database, and
creating a portion of said one or more associations with artificial intelligence applied to said obit index table.

3. The method of indexing obituary information and alerting potentially concerned parties from claim 1, wherein:
said method of indexing obituary information and alerting potentially concerned parties comprises said device application for use by said plurality of users;
2300/comprises said server application for
indexing said plurality of users and said one or more associations in said application database,
indexing said one or more obituary sources and updating said application database with said one or more obituary sources, and
notifying said one or more living users on related information for a one or more deceased users among said plurality of users based on said one or more obituary sources and said one or more associations.

4. The method of indexing obituary information and alerting potentially concerned parties from claim 1, wherein:
said one or more associations comprise a list of persons being of interest to said plurality of users can comprise those with common associations having been manually set in said device application.

5. The method of indexing obituary information and alerting potentially concerned parties from claim 1, wherein:
said one or more associations comprise a list of persons being of interest to said plurality of users can comprise those with common associations having been manually set in said device application;
said method of indexing obituary information and alerting potentially concerned parties comprises said device application for use by said plurality of users;
said method of indexing obituary information and alerting potentially concerned parties comprises said server application for
indexing said plurality of users and said one or more associations in said application database,
indexing said one or more obituary sources and updating said application database with said one or more obituary sources; and
notifying said one or more living users on related information for said one or more deceased users among said plurality of users based on said one or more obituary sources and said one or more associations.
